(19) United States
(12) Patent Application Publication
(10) Pub. No.: US 2025/0081031 A1
(43) Pub. Date: Mar. 6, 2025

(54) RELAY OPERATIONS IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US); Elliot Jen, Taipei City (TW)

(21) Appl. No.: 18/814,408

(22) Filed: Aug. 23, 2024

Related U.S. Application Data
(60) Provisional application No. 63/536,767, filed on Sep. 6, 2023.
(60) Provisional application No. 63/542,207, filed on Oct. 3, 2023.
(60) Provisional application No. 63/546,431, filed on Oct. 30, 2023.

(51) Int. Cl. H04W 28/02; H04W 24/02; H04W 84/12

(52) U.S. Cl. CPC H04W 28/0284; H04W 24/02; H04W 84/12

(57) ABSTRACT

A first device associated with a second device in a wireless network, the first device comprising at least one station (STA) affiliated with the first device and a processor coupled to the at least one STA, the processor configured to perform a relay operation for a second STA that relays a frame between the second STA and a third STA, determine a change in an operational status of the first STA that is indicative of an overload condition of the first STA, determine to suspend the relay operation for the second STA based on the operational status, and transmit, to the second STA, a relay suspension message that indicates a suspension of the relay operation for the second STA.

### CROSS-REFERENCE TO RELATED APPLICATIONS

This application claims the benefit of priority from U.S. Provisional Application No. 63/536,767 entitled “Procedures for Relay Operation Suspension in Next Generation Wi-Fi Networks” filed Sep. 6, 2023, U.S. Provisional Application No. 63/542,207 entitled “Switching Procedure for Relay Operation” filed Oct. 3, 2023, and U.S. Provisional Application No. 63/546,431 entitled “Relay To Relay Transition Procedures For Next Generation Wi-Fi Networks” filed Oct. 30, 2023, all of which are incorporated herein by reference in their entireties.

### TECHNICAL FIELD

This disclosure relates generally to a wireless communication system, and more particularly to, for example, but not limited to, relay operations in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first station (STA) in a wireless network. The first STA comprises a memory and a processor coupled to the memory. The processor is configured to perform a relay operation for a second STA that relays a frame between the second STA and a third STA. The processor is configured to determine a change in an operational status of the first STA that is indicative of an overload condition of the first STA. The processor is configured to determine to suspend the relay operation for the second STA based on the operational status. The processor is configured to transmit, to the second STA, a relay suspension message that indicates a suspension of the relay operation for the second STA.

In some embodiments, the third STA is an access point (AP) STA.

In some embodiments, the operational status includes a traffic load of the first STA or a number of other STAs for which the first STA performs relay operations.

In some embodiments, the overload condition is based on a Quality of Service (QoS) requirement of the first STA or a QoS requirement of the second STA.

In some embodiments, the processor is further configured to determine that a condition to resume the relay operation for the second STA is met, and transmit, to the second STA, a relay resumption message that indicates a resumption of the relay operation for the second STA.

In some embodiments, the processor is further configured to transmit, to the AP, a request message to negotiate suspension of the relay operation, receive, from the AP, a response message that includes indication for the suspension of the relay operation, and suspend the relay operation based on the indication included in the response message.

In some embodiments, the processor is further configured to advertise the suspension of the relay operation to one or more STAs.

In some embodiments, the relay operation is a first relay operation, wherein the processor is further configured to continue to perform a second relay operation for a fourth STA and the second relay operation for the fourth STA relays a frame between the fourth STA and a fifth STA.

In some embodiments, the processor is further configured to receive, from the AP, a request message that requests information on the operational status of the first STA, and provide, to the AP, a response message that includes information on the operational status of the first STA, wherein the AP advertises the operational status of the first STA.

In some embodiments, the relay suspension message includes a time at which the relay operation will be suspended.

One aspect of the present disclosure provides a first station (STA) in a wireless network. The first STA comprises a memory and a processor coupled to the memory. The processor is configured to transmit frames to a second STA that performs a first relay operation that relays a frame between the first STA and a third STA. The processor is configured to receive a relay suspension message from the second STA indicating a suspension of the first relay operation, wherein the second STA experiences an overload condition. The processor is configured to transmit a frame to the third STA directly or via a fourth STA that performs a second relay operation.

In some embodiments, the third STA is an access point (AP) STA

In some embodiments, the processor is further configured to receive, from the second STA, a relay resumption message that indicates a resumption of the first relay operation, and resume transmitting, to the second STA, frames to be relayed by the second STA to the third STA.

In some embodiments, the processor is further configured to transmit, to the second STA, a request message that requests an operational status of the second STA, receive, from the second STA, a response message that includes the operational status of the second STA, and advertise the operational status of the second STA to one or more STAs.

In some embodiments, the processor is further configured to advertise one or more STAs that have a capability to perform a relay operation to an STA associated with the first STA.

In some embodiments, the processor is further configured to transmit a switch message to the second STA that indicates that the first STA intends to switch to the fourth STA, wherein the fourth STA will provide a third relay operation for the first STA.

One aspect of the present disclosure provide a computer-implemented method for wireless communication at a first station (STA) in a wireless network. The method comprises performing a relay operation for a second STA that relays a frame between the second STA and a third STA. The method comprises determining a change in an operational status of the first STA that is indicative of an overload condition of the first STA. The method comprises determining to suspend the relay operation for the second STA based on the operational status. The method comprises transmitting, to the second STA, a relay suspension message that indicates a suspension of the relay operation for the second STA.

In some embodiments, the method further comprises determining that a condition to resume the relay operation for the second STA is met, and transmitting, to the second STA, a relay resumption message that indicates a resumption of the relay operation for the second STA.

In some embodiments, the operational status includes a traffic load of the first STA or a number of other STAs for which the first STA performs relay operations.

In some embodiments, the overload condition is based on a Quality of Service (QoS) requirement of the first STA or a QoS requirement of the second STA.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a flow chart of a process for relay operation suspension in accordance with an embodiment.

FIG. 5 illustrates a flow chart of a process for relay resumption in accordance with an embodiment.

FIG. 6 illustrates a flow chart of a process for relay suspension negotiation in accordance with an embodiment.

FIG. 7 illustrates a flow chart of a process for negotiation response in accordance with an embodiment.

FIG. 8 illustrates an example suspension indication in accordance with an embodiment.

FIG. 9 illustrates an example suspension negotiation procedure in accordance with an embodiment.

FIG. 10 illustrates a beacon-based advertisement procedure for suspension in accordance with an embodiment.

FIG. 11 illustrates an example STA side relay operational status check procedure in accordance with an embodiment.

FIG. 12 illustrates a flow chart of an example process for an AP advertisement for trusted relays in accordance with an embodiment.

FIG. 13 illustrates a flow chart of an example process for switch message transmission in accordance with an embodiment.

FIG. 14 illustrates an AP side notification procedure in accordance with an embodiment.

FIG. 15 illustrates a flow chart of an example process of STA side switching in accordance with an embodiment.

FIG. 16 illustrates a flow chart of an example process for notification message transmission in accordance with an embodiment.

FIG. 17 illustrates communication between an AP, relay and STA to switch from the relay to the AP.

FIG. 18 illustrates communication between an STA, AP, and relay where the STA wants to switch from the AP to the relay in accordance with an embodiment.

FIG. 19 illustrates STA switching in accordance with an embodiment.

FIG. 20 illustrates a timeline for STA switching relays in accordance with an embodiment.

FIG. 21 illustrates a timeline for an STA relay transition in accordance with an embodiment.

FIG. 22 illustrates a timeline for an STA switching relays in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

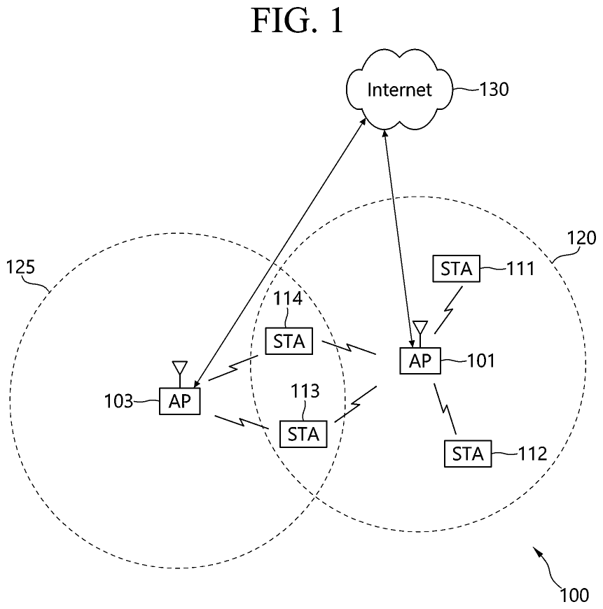

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

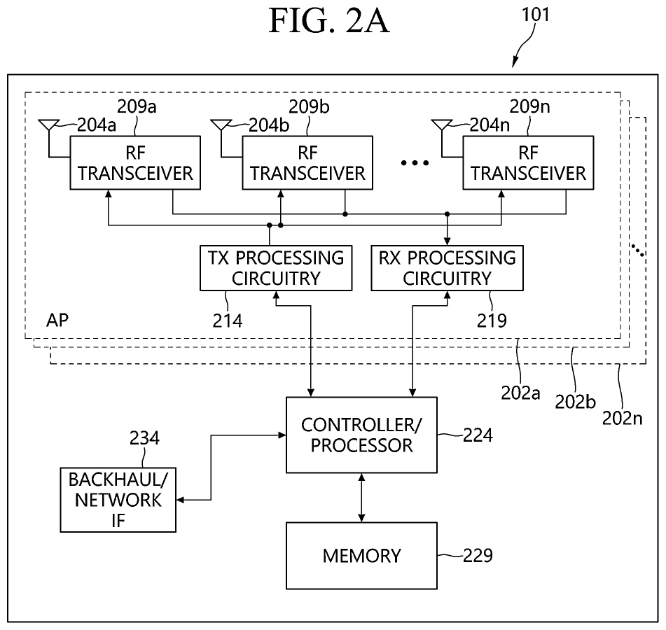

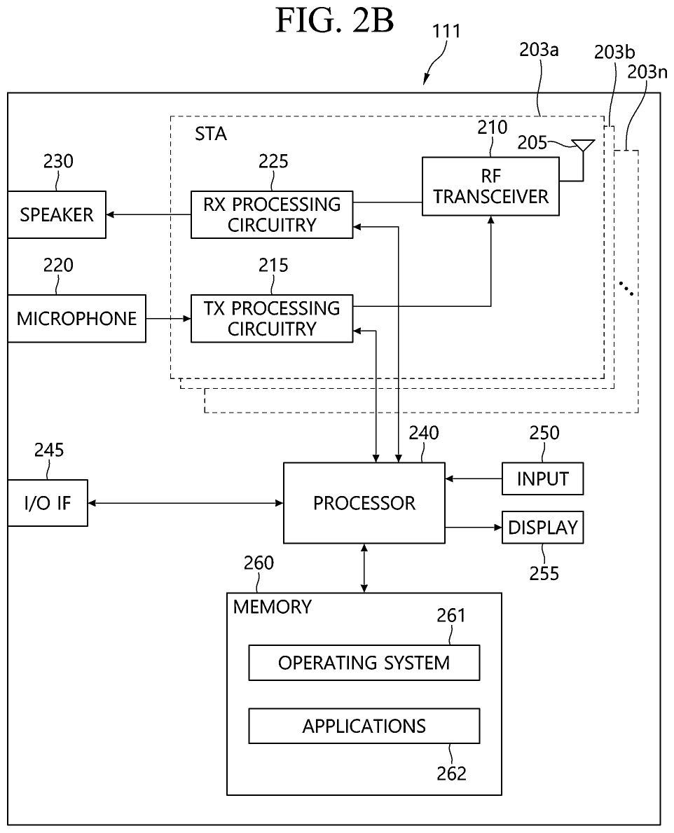

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

Embodiments in accordance with this disclosure may increase the range of wireless connectivity of an access point (AP) so that users can get connectivity in areas where the AP signal is weak/not available. In some embodiments, a relay can be used for supporting this functionality. A relay can act as an intermediate node that can forward packets received from the AP to the non-AP. An example scenario for use of relay can be that of a smart home where there can be a number of devices such as TV, tablets, etc. that have wireless communications support. These devices can act as relays to enhance the range of the access point.

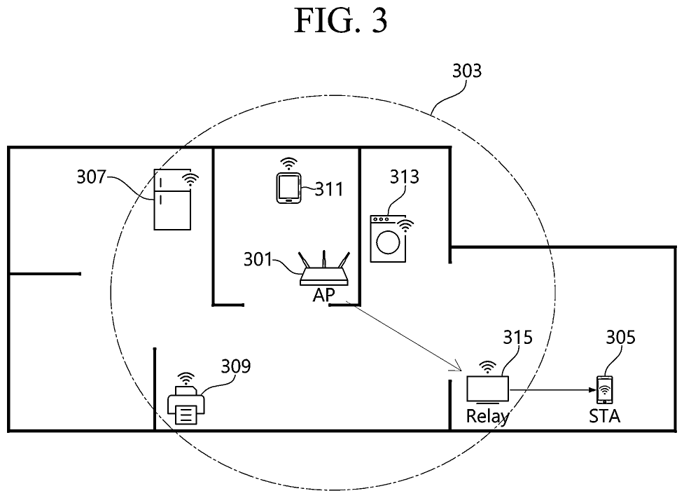

FIG. 3 illustrates an example of a relay in a home environment in accordance with an embodiment. As illustrated, the AP's 301 range is shown by the dotted circle 303. When a user steps outside this circle 303, the user's device, STA 305, may get a poor connection or the connection may be unavailable. A relay can act as an intermediate node and forward the user's traffic so that even when the user is in weak connection areas, it can continue to receive wireless connectivity. As illustrated, the environment includes several devices 307, 309, 311, and 313, and 315. As illustrated, device 315 is indicated as the relay between the AP 301 and user's STA 305.

In some embodiments, the user can be inside the AP's range but there can be a transmit power asymmetry. For example, due to power constraints, the user's device can be transmitting at lower power compared to the AP (which can be wall powered and hence can transmit at higher power). Consequently, the user can be able to hear the AP's transmission. However, on the uplink, the AP may not be able to hear the user's transmission. Accordingly, a relay can be useful in such scenarios as well.

Hereinafter, relay suspension in accordance with this disclosure is described. In some embodiments, a device performing relay functionalities can have other types of traffic that it may need to handle. For example, a relay may be a Mobile AP or another AP and can have its own associated STAs. These STAs can have their own quality of service (QoS) requirements that the AP may also need to satisfy while serving as a relay. As such, various scenarios may arise where it may be problematic for a relay to service all the various needs of different STAs. For example, it is possible that the STAs for which the device acts as a relay can have an increase in their traffic load. Likewise, the number of STAs that decide to have their traffic relayed may increase. As such, a relay may need to provide an indication to the STAs regarding a temporary saturation condition in order to avoid getting overloaded.

In another example, a relay can be a non-AP STA and can thus have its own traffic with corresponding QoS requirements that may need to be fulfilled while the non-AP STA performs relay operations. If a temporary saturation or overload condition arises, then the non-AP STA's own traffic's QoS requirements can get violated. In another example, the relay can have its own power save requirements and may want to go into doze state to conserve battery life. Accordingly, it may be necessary for a relay to temporarily suspend the relay operations. As described herein, embodiments in accordance with the disclosure provide various procedures and signaling to indicate a temporary suspension of relay operations.

In some embodiments, when a STA switches from an AP to a relay or vice versa, a procedure may be used to handle the switching operation. In some embodiments, as a user moves from one point to another, the current relay may not be suitable for relay operations for the STA. Accordingly, the STA may need to switch to a new relay using a switching procedure to enable a smooth transition. In some embodiments, a relay can provide an indication of a temporary suspension of relay activities. The indication message can include at least one or more of the information items as indicated in Table 1 in accordance with an embodiment.

TABLE 1

| Information | |
|---|---|
| item | Description |
| Relay | An information item that can indicate the suspension of relay activities. |
| suspension | E.g., this can be a field (e.g., a bit) that can take a predetermined value (e.g., |
| indication | 0) to indicate suspension and another predetermined value (e.g., 1) to |
| | indicate that the relay operations have resumed. In some embodiments, this |
| | can be a reason code that can indicate that the reason for sending this |
| | message is to indicate a relay suspension indication. In some embodiments, |
| | this can be a status code that can indicate that the status of relay operation |
| | has been updated to being suspended. |
| Start time | An information item that can indicate the time at which the relay |
| | suspension can go into effect. This can be used to provide a warning |
| | beforehand so that the AP and STA can adapt their operations (e.g., chose a |
| | different relay) if necessary before the relay suspension occurs. |
| Duration | An information item that can indicate the duration of time for which the |
| | relay activities can be suspended. E.g., if the relay is going into a doze state |
| | to save power, then the relay can indicate the duration from the start time |
| | for which the relay can stay in that state. |
| STA | An information item that can indicate the suspension of relay operations for |
| indication | a select set of STAs. This information item can be a list of STA identifiers |
| | such as MAC addresses, AIDs, etc. Instead of suspending the relay |
| | operation for all the STAs that are using the relay, the relay can choose to |
| | suspend the operation for only a select set of STAs. The relay can still serve |
| | the other STAs. In some embodiments, the relay can indicate the STAs for |
| | which the suspension does not apply. The ones not mentioned can consider |
| | their relay services to be suspended. |
| Link | If the suspension is for a select set of links, then the relay can make an |
| indication | indication of which links for which it plans to suspend the relay operation. |
| | E.g., this can be a link ID bitmap indicating either links for which the |
| | operation can be suspended. One example scenario where such an |
| | indication can be useful can be when one or more STAs affiliated with the |
| | relay go into doze state to conserve power. |

In some embodiments, the above information items can be transmitted together or separately and can be transmitted as a part of any existing frame/element/field/subfield in the standard or can be a part of newly defined ones.

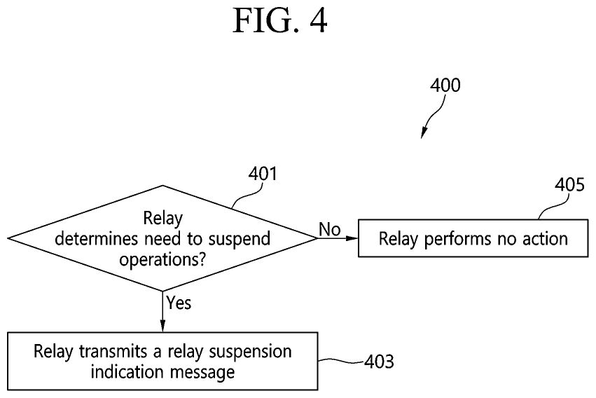

FIG. 4 illustrates a flow chart of a process for relay operation suspension in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 4 illustrates operations performed by a relay, such as the relay illustrated in FIG. 3.

The process 400, in operation 401, a relay determines whether it needs to suspend operations. If in operation 401, the relay that it does need to suspend operations, in operation 403, the relay transmits a relay suspension indication message. A relay suspension indication message can include one or more of the items in Table 1. If in operation 401, the relay determines that it does not need to suspend operations, then in operation 405, the relay performs no action.

In some embodiments, when the relay resumes its operations, the relay can transmit a relay operation resumption message. The relay operation resumption message can include at least one or more of the information items as indicated in Table 2.

TABLE 2

| Information | |
|---|---|
| item | Description |
| Relay | An information item that can indicate the resumption of relay activities. |
| resumption | E.g., this can be a field (e.g., a bit) that can take a predetermined value |
| indication | (e.g., 1) to indicate resumption. In some embodiments, this can be a reason |
| | code that can indicate that the reason for sending this message is to |
| | indicate a relay resumption indication. In some embodiments, this can be a |
| | status code that can indicate that the status of relay operation has been |
| | updated to being resumed. |
| Start time | An information item that can indicate the time at which the relay |
| | resumption can go into effect. This can be used to provide a warning |
| | beforehand so that the AP and STA can adapt their operations (e.g., if they |
| | plan to switch back to the relay) if necessary before the relay resumption |
| | occurs. |
| Duration | An information item that can indicate the duration of time for which the |
| | relay activities can be resumed. E.g., if the relay is going into a doze state |
| | to save power again in the future, then the relay can indicate the duration |
| | from the start time for which the relay can stay in active state. |
| STA | An information item that can indicate the resumption of relay operations |
| indication | for a select set of STAs. This information item can be a list of STA |
| | identifiers such as MAC addresses, AIDs, etc. Instead of resuming the |
| | relay operation for all the STAs that are using the relay, the relay can |
| | choose to resume the operation for only a select set of STAs. The relay can |
| | still suspend relay operations for the other STAs. In some embodiments, |
| | the relay can indicate the STAs for which the resumption does not apply. |
| | The ones not mentioned can consider their relay services to be resumed. |
| Link | If the resumption is for a select set of links, then the relay can make an |
| indication | indication of which links for which it plans to resume the relay operation. |
| | E.g., this can be a link ID bitmap indicating either links for which the |
| | operation can be resumed. One example scenario where such an indication |
| | can be useful can be when one or more STAs affiliated with the relay go |
| | into doze state to conserve power and plans to come out of the doze state |
| | (in this case the indication can be made cross link) or has already come out |
| | of the doze state. |

In some embodiments, the above information items can be transmitted together or separately and can be transmitted as a part of any existing frame/element/field/subfield in the standard or can be a part of newly defined ones.

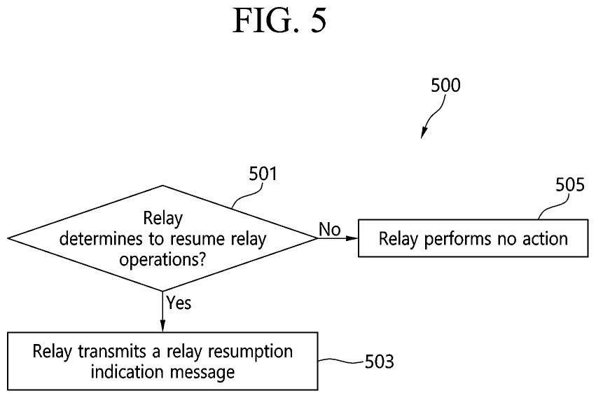

FIG. 5 illustrates a flow chart of a process for relay resumption in accordance with an embodiment. Although one or more operations are described or shown in particular sequential order, in other embodiments the operations may be rearranged in a different order, which may include performance of multiple operations in at least partially overlapping time periods. The flowchart depicted in FIG. 5 illustrates operations performed in a relay, such as the relay illustrated in FIG. 3.

The process 500, in operation 501, the relay determines whether to resume relay operations. If in operation 501, the relay determines to resume relay operations, then in operation 503 the relay transmits a relay resumption indication message. In some embodiments, the relay operation resumption message can include one or more of the information items provided in Table 2.

If in operation 501, the relay determines not to resume relay operations, then in operation 505 the relay performs no action.

In some embodiments, if an AP (or an AP affiliated with an AP MLD) receives a temporary suspension indication, the AP can stop sending traffic of the STAs under consideration for the suspension to the relay until the relay operations are resumed for those STAs. After relay operations are resumed, if the STAs have chosen to remain with the same relay, the AP can resume transmission and reception of traffic to and from the relay. During relay suspension, the AP can prevent other relays from setting up relay transmissions using the relay that has suspended its operation.

In some embodiments, if an STA (or an STA affiliated with a non-AP MLD) receives a temporary suspension indication, the STA can stop sending traffic to the AP via the relay. After the relay operations are resumed for the STA, the STA can resume transmission and reception of traffic to and from the relay. During the suspension, the STA can also perform power save to conserve its power.

In some embodiments, after a relay transmits the message at an indicated start time, the relay can suspend the relay operation for the indicated STAs. In some embodiments, STAs that receive an indication of the relay operation suspension can chose to not relay traffic through the relay that has suspended its relay operation.

In some embodiments, a suspension can be negotiation based. In some embodiments, the relay can transmit a temporary suspension negotiation message and based on the outcome of the negotiation decide which STAs to suspend the relay operations.

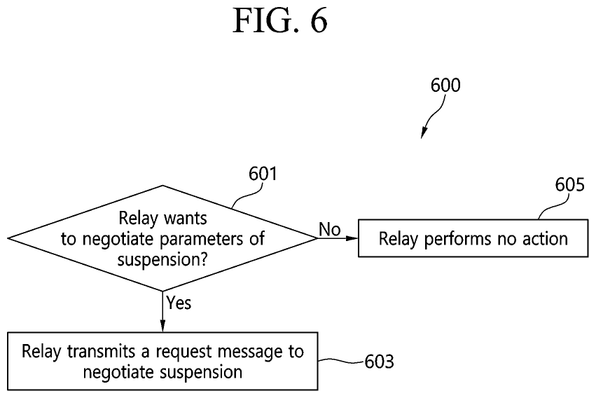

FIG. 6 illustrates a flow chart of a process for relay suspension negotiation in accordance with an embodiment. Although one or more operations are described or shown in particular sequential order, in other embodiments the operations may be rearranged in a different order, which may include performance of multiple operations in at least partially overlapping time periods. The flowchart depicted in FIG. 4 illustrates operations performed by a relay, such as the relay illustrated in FIG. 3. The process 600, in operation 601, the relay determines whether it wants to negotiate parameters for suspension. If in operation 601, the relay determines that it does want to negotiate parameters for suspension, then in operation 603, the relay transmits a request message to negotiate suspension. If in operation 601, the relay determines that it does not want to negotiate parameters for suspension, then in operation 605, the relay performs no action.

In some embodiments, the relay can transmit a negotiation message to the AP. The request message can include at least one or more of the information items as indicated in Table 3.

TABLE 3

| Information | |
|---|---|
| items | Description |
| Reference | An information item that can serve as a reference for this request. E.g., a |
| indicator | dialog token. |
| Suspension | An information item that can indicate the relay's intention for suspension |
| intent | of relay activities. E.g., this can be a field (e.g., a bit) that can take a |
| indication | predetermined value (e.g., 0) to indicate the intention. In some |
| | embodiments, this can be a reason code that can indicate that the reason |
| | for sending this message is to indicate a relay suspension intention. |
| Start time | An information item that can indicate the time at which the relay |
| | suspension can go into effect. |
| Duration | An information item that can indicate the duration of time for which the |
| | relay activities can be suspended. |
| STA | An information item that can indicate the STAs for which the relay |
| indication | operations can be suspended. E.g., list of STA MAC addresses, AIDs, etc. |
| Link | An information item that can indicate the link(s) for which the relay |
| indication | operations can be suspended. E.g., a link ID bitmap. |
| Reason | An information item that can describe the reason for sending the request |
| indicator | message. E.g., relay may want to do the negotiation to save power and go |
| | to doze state. |

The above information items can be transmitted together or separately and can be transmitted as a part of any existing frame/element/field/subfield in the standard or can be a part of newly defined ones.

Upon receiving the above message, the recipient (e.g., the AP) can process the message and can transmit a response frame that can include at least one or more of the information items as indicated in Table 4.

TABLE 4

| Information | |
|---|---|
| items | Description |
| Reference | An information item that can indicate the request to which the response |
| indicator | message corresponds to. E.g., the same dialog token value that was present |
| | in the request message. |
| Status | An information item that can indicate the status of the request message to |
| indicator | which the response message corresponds to. E.g., a status code. For |
| | instance, if the responder does not have an immediate response but can |
| | respond in the future then the status code can be used to make such an |
| | indication. Status code can also be used to indicate success/denial of the |
| | request. If the request is denied, the response message may not include the |
| | other parameters mentioned in this table. |
| Start time | An information item that can indicate the time at which the relay |
| | suspension can go into effect. This can be the value that is permitted by the |
| | AP. E.g., AP may have some urgent traffic for the STA and may want the |
| | relay to choose a different start time. |
| Duration | An information item that can indicate the duration of time for which the |
| | relay activities can be suspended. This can be the value that is permitted by |
| | the AP. E.g., the AP may want the relay to resume operations earlier than |
| | the value indicated by the relay to serve the STA earlier. |
| STA | An information item that can indicate the STAs for which the relay |
| indication | operations can be suspended. E.g., list of STA MAC addresses, AIDs, etc. |
| | The AP can decide the list of STAs based on its understanding of their |
| | traffic characteristics, QoS requirements, etc. |
| Link | An information item that can indicate the link(s) for which the relay |
| indication | operations can be suspended. E.g., a link ID bitmap. The AP can decide |
| | the links for which the relay can suspend the relay operations. |

The above information items can be transmitted together or separately and can be transmitted as a part of any existing frame/element/field/subfield in the standard or can be a part of newly defined ones. Upon receiving the response frame, the relay can perform suspension operation as per the parameters indicated in the response frame.

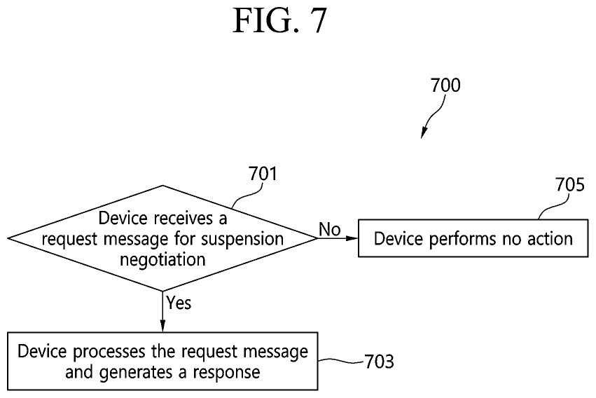

FIG. 7 illustrates a flow chart of a process for negotiation response in accordance with an embodiment. Although one or more operations are described or shown in particular sequential order, in other embodiments the operations may be rearranged in a different order, which may include performance of multiple operations in at least partially overlapping time periods. The flowchart depicted in FIG. 4 illustrates operations performed by a device, such as a device illustrated in FIG. 3. The process 700, in operation 701, a device determines whether it receives a request message for suspension negotiation. If in operation 701, the device determines that it does receive a request message for suspension negotiation, then in operation 703 the device processes the request message and generates a response. If in operation 701, the device determines that it does not receive a request message for suspension negotiation, then in operation 705 the device performs no action.

In some embodiments, the relay can advertise the suspension. In some embodiments, if the relay is a Mobile AP/AP then the relay can advertise the suspension in beacon frames that it transmits. The advertisement message can include at least one or more of the information items as indicate in Table 5.

TABLE 5

| Information | |
|---|---|
| item | Description |
| Relay | An information item that can indicate the resumption/suspension of relay |
| operational | activities. E.g., this can be a field (e.g., a bit) that can take a predetermined |
| status | value (e.g., 1) to indicate resumption and to another predetermined value |
| | (e.g., 0) to indicate suspension. |
| Start time | An information item that can indicate the time at which the relay |
| | suspension can go into effect. This can be used to provide a warning |
| | beforehand so that the AP and STA can adapt their operations (e.g., if they |
| | plan to switch back to the relay) if necessary before the relay suspension |
| | occurs. |
| Duration | An information item that can indicate the duration of time for which the |
| | relay activities can be suspended. E.g., if the relay is going into a doze |
| | state to save power again in the future, then the relay can indicate the |
| | duration from the start time for which the relay can stay in active state. |
| STA | An information item that can indicate the set of STAs that the relay is |
| indication | currently serving. This information item can be a list of STA identifiers |
| | such as MAC addresses, AIDs, etc. STAs not present in the list can assume |
| | relay operation being suspended for them. |
| Link | An information item that can indicate the link(s) for which the relay |
| indication | operation is active. E.g., the indication can be made via a link ID bitmap. |
| | For other link(s) not indicated, relay operation can be considered as |
| | suspended. |

The above information items can be transmitted together or separately and can be transmitted as a part of any existing frame/element/field/subfield in the standard or can be a part of newly defined ones.

In some embodiments, if the relay is a Mobile AP/AP, then the relay can include the advertisement message in its management frame such as beacons, probe responses, association responses, among other types of frames that it transmits.

In some embodiments, when the root AP hears a beacon from the relay that indicates suspension of relay activities, the AP can understand the relay's suspension plan and can consider the relay operation suspended at the indicated time. The AP can also stop sending the indicated STAs' traffic to the relay until the relay operation resumes. The AP can continue to transmit and receive traffic from the relay for the STAs for whom relay operations are not suspended.

In some embodiments, when the STA hears a beacon from the relay that indicates suspension of relay activities, the STA can understand the relay's suspension plan and can consider the relay operations suspended at the indicated time. The STA can also stop sending the uplink and/or downlink traffic to the relay until the relay operation resumes. An STA for whom relay operations are not suspended can continue to transmit and receive traffic from the relay.

In some embodiments, the AP can advertise the relay's operational status. The AP can advertise if the relay is in operational status or in suspended mode. The AP can transmit an advertisement message for the STA that includes at least one or more of the information items as indicated in Table 5. The AP can either check for the relay's operational status on its own or the AP can find out the relay's operational status after it hears the relay's advertisement message.

In some embodiments, a request message can be transmitted to the relay to check its operational status. The relay can share a response message that includes at least one or more of the information items as indicated in Table 5. Based on this request and response procedure, the AP and/or the STA can determine the relay's operational status.

In some embodiments, if a relay can temporarily suspend its operations, then it can make an indication of such a constraint/capability in at least one or more information frames that it transmits. In some embodiments, the relay can include such an indication in a field transmitted in a management frame such as a beacon, probe response frames, among other types of frames. This can enable the devices to understand the relay's constraint. The devices can then use the relay in an informed manner or choose to use another relay that may not have such a constraint.

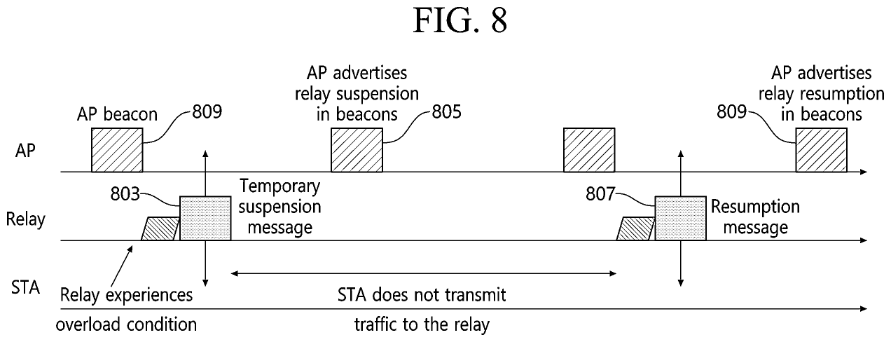

FIG. 8 illustrates an example suspension indication in accordance with an embodiment. As illustrated, a relay may experience an overload condition. Upon experiencing an overload condition, the relay may generate a temporary suspension message 803 and transmit it (in this example as a broadcast/group cast message) to the AP and the STA(s). Upon receiving the message, the STA may not transmit any further traffic to the relay. The AP may also stop transmitting any downlink traffic for the STA(s) to the relay. The AP may also advertise the relay suspension in its beacon messages 805 so that other STAs don't attempt to setup relay operations with the particular relay when its operations are suspended. When the relay assesses that it can resume relay operations, it can transmit a resumption message 807. Upon receiving the resumption message, the AP and the STA can start communication again. Further, the AP can also start to advertise the relay resumption in the beacon messages 809 that it transmits.

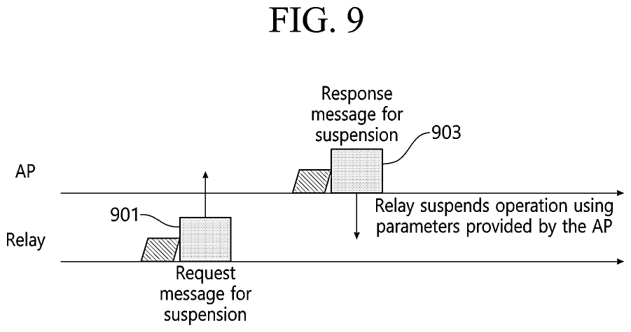

FIG. 9 illustrates an example suspension negotiation procedure in accordance with an embodiment. As illustrated, the relay and the AP can negotiate the suspension. The relay can transmit a request message 901 for relay operation suspension. The AP can process the message and transmit a response message 903 for the suspension. In some embodiments, the relay may suspend operations using parameters provided by the AP.

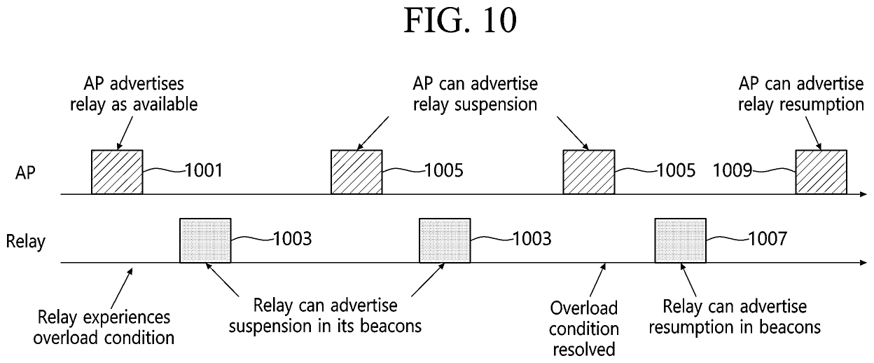

FIG. 10 illustrates a beacon-based advertisement procedure for suspension in accordance with an embodiment. As illustrated, the AP may advertise the relay as available in its beacons 1001. At a certain point, the relay may experience an overload condition. Upon experiencing an overload condition, the relay may start to advertise suspension in beacons 1003 that it transmits. Likewise, the AP may start to advertise the relay suspension in the beacons 1005 that it transmits. When the overload condition is resolved, the relay can advertise resumption in its beacons 1007. Upon receiving the relay beacons, the AP can also advertise the resumption in its beacons 1009.

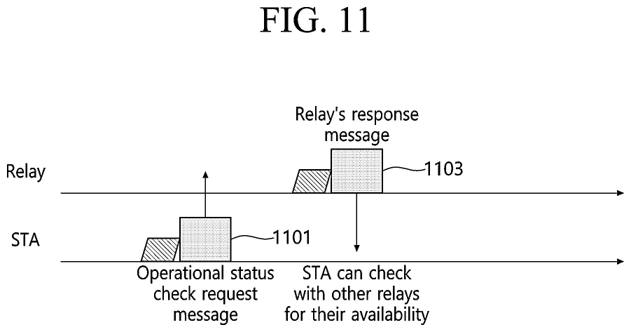

FIG. 11 illustrates an example STA side relay operational status check procedure in accordance with an embodiment. The STA can transmit an operational status check request message 1101 (e.g., via an action frame). The AP can process the status check request message 1101 and generate a response message 1103. Upon receiving the message, the STA can check with other relays for their availability. Although the embodiments in this disclosure are described in the context of AP and STA, they can also apply to multi-link operation.

In some embodiments, the AP can advertise a list of trusted relays that can serve its associated STAs. This can be done by transmitting a trusted relay advertisement message. The message can include at least one or more of the information items as indicated in Table 6.

TABLE 6

| Information | |
|---|---|
| item | Description |
| Relay | An information item that can describe the relays that the STA associated |
| identifier(s) | with the AP can use to communicate to the AP. E.g., a list of relay IDs, a |
| | list of relay MAC addresses, etc. |
| Relay state | An information item that can describe the state of the relay(s) that the |
| indicator(s) | STA associated with the AP can use to communicate to the AP. E.g., if |
| | the relays intend to perform power save, then a list of relays that are in |
| | active state can be advertised. |
| Relay | An information item that can describe any constraints for the indicated |
| constraint | relay(s). In some embodiments, one or more of the relays can have a |
| indicator(s) | buffer size limitation which can lead to a degraded performance for an |
| | STA that intends to or is performing a large file download. In such a case, |
| | the constraint for the relay can be advertised. |
| STA count | An information item that can describe the number of STA(s) that the |
| indicator | indicated relay(s) are already serving. This information can help the STA |
| | to choose the best relay for itself. |
| Relay to AP | An information item that can describe the signal strength at the AP for the |
| signal strength | transmissions from the relay. E.g., RSSI, SNR, etc. This information can |
| indicator | help the STA to choose the best relay for itself. |
| AP to relay | An information item that can describe the signal strength at the relay for |
| signal strength | the transmissions from the AP. E.g., RSSI, SNR, etc. This information |
| indicator | can help the STA to choose the best relay for itself. |

The above information items can be transmitted together or separately and can be transmitted as a part of any existing frame/element/field/subfield in the standard or can be a part of newly defined ones.

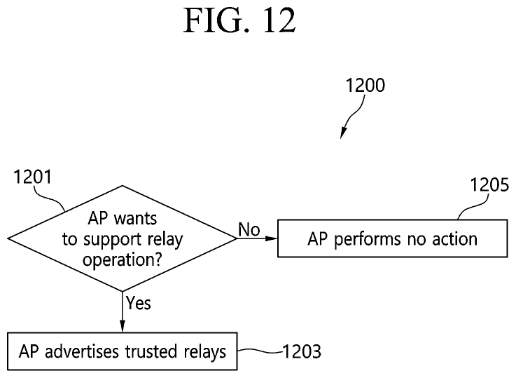

FIG. 12 illustrates a flow chart of an example process for an AP advertisement for trusted relays in accordance with an embodiment. Although one or more operations are described or shown in particular sequential order, in other embodiments the operations may be rearranged in a different order, which may include performance of multiple operations in at least partially overlapping time periods. The flowchart depicted in FIG. 12 illustrates operations performed by an AP, such as the AP illustrated in FIG. 3. The process 1200, in operation 1201, the AP determines whether it wants to support relay operations. If in operation 1201, the AP determines that it wants to support relay operations, then in operation 1203 the AP advertises one or more trusted relays. If in operation 1201, the AP determines that it does not want to support relay operations, then in operation 1205, the AP performs no action.

In some embodiments, when an STA receives an advertisement message from the AP, the STA can use the advertisement message content to understand the active relays and assess the best relay from among them.

In some embodiments, an STA can transmit a switch message to an AP to inform the AP about its intention to switch from the AP to the relay. The switch message from the STA can include at least one or more of the information items as indicated in Table 7.

TABLE 7

| Information | |
|---|---|
| item | Description |
| Current AP | An information item that can describe the current AP's identification. |
| identifier | E.g., AP MAC address, BSSID, etc. |
| Relay identifier | An information item that can describe the identification of the relay. E.g., |
| | Relay ID, Relay MAC address, etc. |
| AP | An information item that can indicate if the STA wants the AP to |
| recommendation | recommend the best/operational relay for the operation. E.g., if the STA |
| requestor | cannot choose the best relay and wants the AP to recommend a list of |
| | relays to choose from. |
| Switch time | An information item that can describe the time at which the switching can |
| | occur. E.g., number of TBTTs until the beacon interval during which the |
| | switch occurs, switching time, etc. |
| Duration | The duration for which the switch can occur. |
| Traffic | An information item that can indicate the direction of the traffic that will |
| direction | be switched from the AP to the relay. E.g., the STA may only want to use |
| indicator | the relay for uplink traffic and downlink traffic can still be directly |
| | transmitted by the AP to the STA. In some embodiments, this signaling |
| | can be done using a field (e.g., one or more bits) which can take a |
| | predetermined value to indicate downlink, another predetermined value to |
| | indicate uplink, a predetermined value to indicate peer to peer, etc. |
| Explicit relay | An information item that can indicate if notifying the relay is necessary or |
| notification | not. E.g., this can be done by using a field (e.g., a bit) that can take a |
| indication | predetermined value (e.g., 1) to make the indication and another |
| | predetermined value (e.g., 0) to indicate otherwise. |
| Relay notifying | An information item that can indicate the entity that can notify the relay |
| entity | about the switch. For example, if the STA wants the AP to do the |
| | notification, the STA can make such an indication. Or if the STA wants to |
| | notify the relay by itself, it can make such an indication as well. |
| Traffic | An information item that can indicate the traffic type that the STA wants |
| identifier | to be relayed. For instance, the STA may prefer low latency traffic |
| | streams to be sent via relay to get the benefit of higher data rate to the |
| | relay and best effort traffic can still be transmitted by the AP to the STA |
| | directly. |
| Stream | An information item that can indicate the streams that the STA wants to |
| identifier | be relayed. For instance, the STA may want only certain application |
| | traffic (e.g., gaming traffic) to be relayed. Other applications, that do not |
| | have latency sensitive traffic can still be transmitted directly to reduce the |
| | burden on the relay. |

The above information items can be transmitted together or separately and can be transmitted as a part of any existing frame/element/field/subfield in the standard or can be a part of newly defined ones.

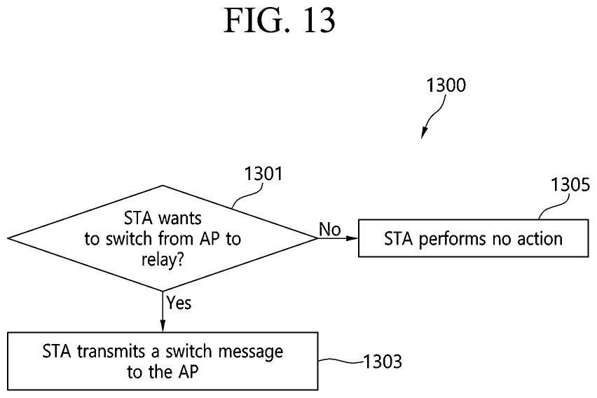

FIG. 13 illustrates flow chart of an example process for switch message transmission in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 13 illustrates operations performed by an STA, such as the STA illustrated in FIG. 3. The process 1300, in operation 1301, the STA determines whether it wants to switch from an AP to a relay. If in operation 1301, the STA determines that it does want to switch from an AP to a relay, then in operation 1303, the STA transmits a switch message to the AP. If in operation 1301, the STA determines that it does not want to switch from an AP to a relay, then in operation 1305, the STA performs no action.

In some embodiments, upon receiving the switch message from the STA, the AP can transmit the frames of the STA to the relay. After the switch, the STA can transmit its uplink and/or downlink traffic to the AP via the relay. After the AP receives the switch message from the STA, the AP can keep the STA's association state and not disassociate the STA. In some embodiments, the STA can explicitly notify the AP about the disassociation if it chooses to disassociate in the future.

In some embodiments, the AP can transmit an acknowledgement message as a response to the STA's switch message. The acknowledgement message from the AP to the STA can include at least one or more of the information items as indicated in Table 8.

TABLE 8

| Information | |
|---|---|
| item | Description |
| AP identifier | An information item that can describe the AP's identification. E.g., AP |
| | MAC address, BSSID, etc. |
| Relay | An information item that can describe the identification of the relay. E.g., |
| identifier | Relay ID, Relay MAC address, etc. |
| AP relay | An information item that can describe the list of relays that the AP |
| recommendation | recommends for the STA. E.g., this can be a list of relay MAC address, |
| | relay IDs, etc. |
| Switch time | An information item that can describe the time at which the switching can |
| | occur. E.g., number of TBTTs until the beacon interval during which the |
| | switch occurs, switching time, etc. This value can be the value that is |
| | suggested by the AP if the value suggested by the STA does not work. |
| Duration | The duration for which the switch can occur. This can be a value suggested |
| | by the AP if the value suggested by the STA does not work. |
| Traffic | An information item that can indicate the direction of the traffic that will be |
| direction | switched from the AP to the relay. This can be a confirmation from the AP. |
| indicator | In one example, this signaling can be done using a field (e.g., one or more |
| | bits) which can take a predetermined value to indicate downlink, another |
| | predetermined value to indicate uplink, a predetermined value to indicate |
| | peer to peer, etc. |
| Relay | An information item that can act as a confirmation for relay notification. |
| notification | For instance, if the STA indicated to the AP that it wants the AP to send the |
| confirmation | notification to the relay, then the AP can confirm that it can do so. |
| Traffic | An information item that can indicate the traffic type that the AP can agree |
| identifier | to relay. |
| Stream | An information item that can indicate the streams that the AP can relay. |
| identifier | |

The above information items can be transmitted together or separately and can be transmitted as a part of any existing frame/element/field/subfield in the standard or can be a part of newly defined ones.

In some embodiments, the AP can also inform the relay about the STA's intention to switch by transmitting a switch notification message to the relay that can include at least one or more of the information items as indicated in Table 9.

TABLE 9

| Information | |
|---|---|
| item | Description |
| Current AP | An information item that can describe the current AP's identification. |
| identifier | E.g., AP MAC address, BSSID, etc. |
| STA identifier | An information item that can describe the STA that is planning to switch. |
| | E.g., STA MAC address, AID, etc. |
| Switch time | An information item that can describe the time at which the switching |
| | can occur. E.g., number of TBTTs until the beacon interval during which |
| | the switch occurs, switching time, etc. This value can be the value that is |
| | suggested by the AP if the value suggested by the STA does not work. |
| Duration | The duration for which the switch can occur. |
| Traffic direction | An information item that can indicate the direction of the traffic that will |
| indicator | be switched from the AP to the relay. E.g., the STA may only want to |
| | use the relay for uplink traffic and downlink traffic can still be directly |
| | transmitted by the AP to the STA. In some embodiments, this signaling |
| | can be done using a field (e.g., one or more bits) which can take a |
| | predetermined value to indicate downlink, another predetermined value |
| | to indicate uplink, a predetermined value to indicate peer to peer, etc. |
| Traffic identifier | An information item that can indicate the traffic type that the STA wants |
| | to be relayed. In some embodiments, the STA may prefer low latency |
| | traffic streams to be sent via relay to get the benefit of higher data rate to |
| | the relay and best effort traffic can still be transmitted by the AP to the |
| | STA directly. |
| Stream identifier | An information item that can indicate the streams that the STA wants to |
| | be relayed. In some embodiments, the STA may want only certain |
| | application traffic (e.g., gaming traffic) to be relayed. Other applications, |
| | that do not have latency sensitive traffic can still be transmitted directly |
| | to reduce the burden on the relay. |

The above information items can be transmitted together or separately and can be transmitted as a part of any existing frame/element/field/subfield in the standard or can be a part of newly defined ones.

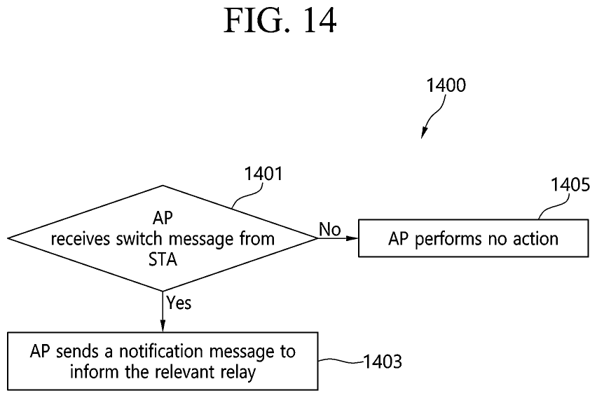

FIG. 14 illustrates an AP side notification procedure in accordance with an embodiment. Although one or more operations are described or shown in particular sequential order, in other embodiments the operations may be rearranged in a different order, which may include performance of multiple operations in at least partially overlapping time periods. The flowchart depicted in FIG. 14 illustrates operations performed by an AP, such as the AP illustrated in FIG. 3. The process 1400, in operation 1401, the AP determines whether it receives a switch message from an STA. If in operation 1401, the AP determines that it does receive a switch message from the STA, then in operation 1403, the AP sends a notification message to inform the relevant relay. If in operation 1401, the AP determines that it does not receive a switch message from the STA, then in operation 1405, the AP performs no action.

In some embodiments, the STA can inform the relay about the intention to switch to the relay. The STA can transmit a switch message to the relay to inform the relay about its intention. The switch message from the STA can include at least one or more of the information items as indicated in Table 10.

TABLE 10

| Information | |
|---|---|
| item | Description |
| AP identifier | An information item that can describe the AP's identification. E.g., AP |
| | MAC address, BSSID, etc. |
| Relay | An information item that can describe the identification of the relay. E.g., |
| identifier | Relay ID, Relay MAC address, etc. |
| Switch time | An information item that can describe the time at which the switching can |
| | occur. E.g., number of TBTTs until the beacon interval during which the |
| | switch occurs, switching time, etc. |
| Duration | The duration for which the switch can occur. |
| Traffic | An information item that can indicate the direction of the traffic that will |
| direction | be switched from the relay to the AP. E.g., the STA may only be using the |
| indicator | relay for uplink traffic and may want to indicate that only uplink traffic be |
| | switched back to the AP. In some embodiments, this signaling can be done |
| | using a field (e.g., one or more bits) which can take a predetermined value |
| | to indicate downlink, another predetermined value to indicate uplink, a |
| | predetermined value to indicate peer to peer, etc. |
| Explicit AP | An information item that can indicate if notifying the AP is necessary or |
| notification | not. E.g., this can be done by using a field (e.g., a bit) that can take a |
| indication | predetermined value (e.g., 1) to make the indication and another |
| | predetermined value (e.g., 0) to indicate otherwise. |
| AP notifying | An information item that can indicate the entity that can notify the relay |
| entity | about the switch. In some embodiments, if the STA wants the AP to do the |
| | notification, the STA can make such an indication. Or if the STA wants to |
| | notify the relay by itself, it can make such an indication as well. |
| Traffic | An information item that can indicate the traffic type that the STA wants to |
| identifier | be switched back to the AP. In some embodiments, the STA may prefer |
| | low latency traffic streams to be sent via relay to get the benefit of higher |
| | data rate to the relay and best effort traffic can be switched back to the AP |
| | to send to the STA directly. This can be useful to reduce the relay's load. |
| Stream | An information item that can indicate the streams that the STA wants to be |
| identifier | switched back to the AP to send directly to the STA. In some |
| | embodiments, the STA may want only certain application traffic (e.g., |
| | gaming traffic) to be relayed. Other applications, that do not have latency |
| | sensitive traffic can still be switched back to the AP to directly transmit to |
| | the STA to reduce the burden on the relay. |

The above information items can be transmitted together or separately and can be transmitted as a part of any existing frame/element/field/subfield in the standard or can be a part of newly defined ones.

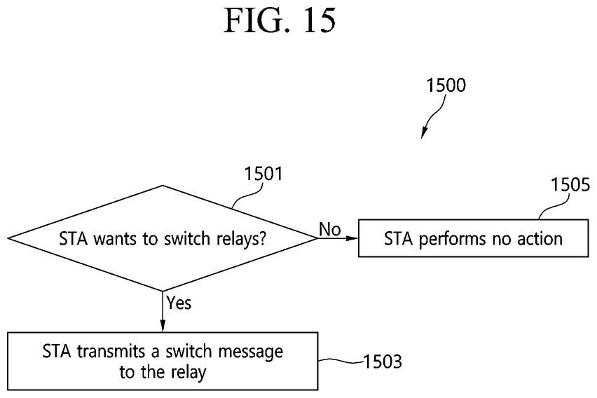

FIG. 15 illustrates a flow chart of an example process of STA side switching in accordance with an embodiment. Although one or more operations are described or shown in particular sequential order, in other embodiments the operations may be rearranged in a different order, which may include performance of multiple operations in at least partially overlapping time periods. The flowchart depicted in FIG. 15 illustrates operations performed by an STA, such as the STA illustrated in FIG. 3. The process 1500, in operation 1501, the STA determines whether it wants to switch relays. If in operation 1501, the STA determines that it does want to switch relays, then in operation 1503, the STA transmits a switch message to the relay. If in operation 1501, the STA determines that it does not want to switch relays, then in operation 1505, the STA performs no action.

In some embodiments, upon receiving the switch message, the relay can transmit an acknowledgement message. The acknowledgement message can include at least one or more of the information items as indicated in Table 11.

TABLE 11

| Information | |
|---|---|
| item | Description |
| AP identifier | An information item that can describe the AP's identification. E.g., AP |
| | MAC address, BSSID, etc. |
| Relay | An information item that can describe the identification of the relay. E.g., |
| identifier | Relay ID, Relay MAC address, etc. |
| Switch time | An information item that can describe the time at which the switching can |
| | occur. E.g., number of TBTTs until the beacon interval during which the |
| | switch occurs, switching time, etc. This value can be the value that is |
| | suggested by the relay if the value suggested by the STA does not work. |
| Duration | The duration for which the switch can occur. This can be a value suggested |
| | by the AP if the value suggested by the STA does not work. |
| Traffic | An information item that can indicate the direction of the traffic that will be |
| direction | switched from the AP to the relay. This can be a confirmation from the AP. |
| indicator | In some embodiments, this signaling can be done using a field (e.g., one or |
| | more bits) which can take a predetermined value to indicate downlink, |
| | another predetermined value to indicate uplink, a predetermined value to |
| | indicate peer to peer, etc. |
| Relay | An information item that can act as a confirmation for relay notification. |
| notification | For instance, if the STA indicated to the AP that it wants the AP to send the |
| confirmation | notification to the relay, then the AP can confirm that it can do so. |
| Traffic | An information item that can indicate the traffic type that the AP can agree |
| identifier | to relay. |
| Stream | An information item that can indicate the streams that the AP can relay. |
| identifier | |

The above information items can be transmitted together or separately and can be transmitted as a part of any existing frame/element/field/subfield in the standard or can be a part of newly defined ones.

In some embodiments, the relay can also inform the AP about the STA's intention to switch by transmitting a notification message to the AP that can include at least one or more of the information items as indicated in Table 12.

TABLE 12

| Information | |
|---|---|
| item | Description |
| AP identifier | An information item that can describe the AP's identification. E.g., AP |
| | MAC address, BSSID, etc. |
| Relay | An information item that can describe the identification of the relay. E.g., |
| identifier | Relay ID, Relay MAC address, etc. |
| Switch time | An information item that can describe the time at which the switching can |
| | occur. E.g., number of TBTTs until the beacon interval during which the |
| | switch occurs, switching time, etc. This value can be the value that is |
| | suggested by the AP if the value suggested by the STA does not work. |
| Duration | The duration for which the switch can occur. This can be a value suggested |
| | by the AP if the value suggested by the STA does not work. |
| Traffic | An information item that can indicate the direction of the traffic that will be |
| direction | switched from the relay to the AP. In some embodiments, this signaling can |
| indicator | be done using a field (e.g., one or more bits) which can take a |
| | predetermined value to indicate downlink, another predetermined value to |
| | indicate uplink, a predetermined value to indicate peer to peer, etc. |
| Traffic | An information item that can indicate the traffic type that can be switched |
| identifier | back to the AP. |
| Stream | An information item that can indicate the streams that can be switched back |
| identifier | to the AP. |

The above information items can be transmitted together or separately and can be transmitted as a part of any existing frame/element/field/subfield in the standard or can be a part of newly defined ones.

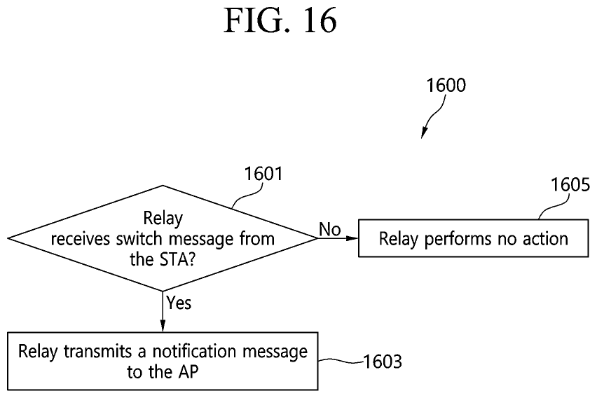

FIG. 16 illustrates a flow chart of an example process for notification message transmission in accordance with an embodiment. Although one or more operations are described or shown in particular sequential order, in other embodiments the operations may be rearranged in a different order, which may include performance of multiple operations in at least partially overlapping time periods. The flowchart depicted in FIG. 16 illustrates operations performed by a relay, such as the relay illustrated in FIG. 3. The process 1600, in operation 1601, the relay determines whether it receives a switch message from an STA. If in operation 1601, the relay determines that it does receive a switch message from the STA, then in operation 1603, the relay transmits a notification message to the AP. If in operation 1601, the relay determines that it does not receive a switch message from the STA, then in operation 1605, the relay performs no action. In some embodiments, when an STA wants to switch from relay to AP, it can transmit a switch message to the AP.

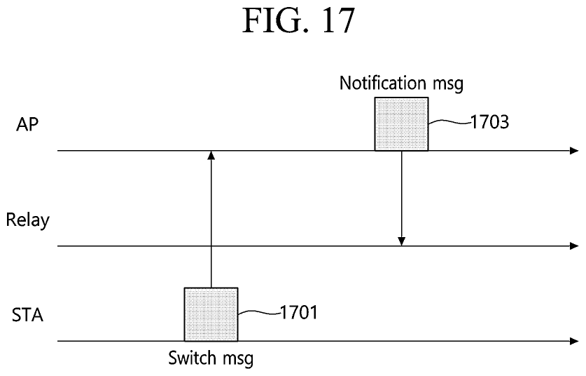

FIG. 17 illustrates communication between an AP, relay and STA to switch from the relay to the AP. As shown in FIG. 17, the STA can transmit a switch message 1701 to the AP and request the AP to transmit the notification message to the relay. The AP can then transmit a notification message 1703 to the relay. In some embodiments, when the STA wants to switch from the AP to the relay, the STA can transmit a switch message to the relay and request the relay to transmit a notification message to the AP.

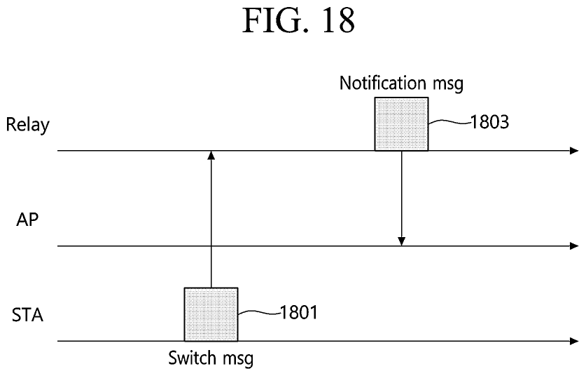

FIG. 18 illustrates communication between an STA, AP, and relay where the STA wants to switch from eh AP the relay in accordance with an embodiment. As illustrated, the STA transmits a switch message 1801 to the relay to request the relay to transmit a notification message to the AP. The relay then transmits a notification message 1803 to the AP. In some embodiments, when STA wants to switch, the STA can send a switch message to both the relay and the AP.

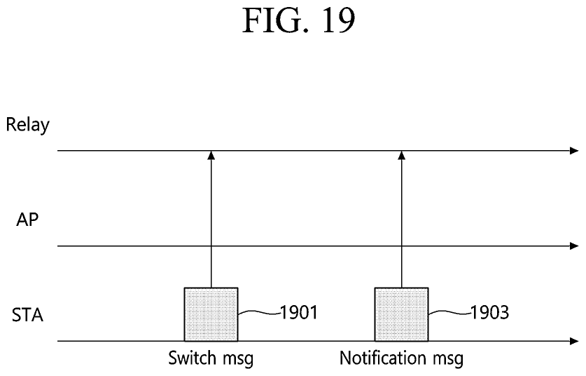

FIG. 19 illustrates STA switching in accordance with an embodiment. As illustrates, the STA broadcasts to the AP and a relay, both a switch message 1901 and a notification message 1903.

In some embodiments, two types of entities may be referred to, which may include a first one is a switching entity. This can be an entity that wants to initiate a relay to relay transition. For instance, this can be an STA that has moved and wants to transition to a new relay. This can also be an AP that wants the STA to move to a different relay due to, for instance, poor performance via the current relay.

The second is a processing entity. This can be an entity that receives and processes the request of the switching entity. For instance, this can be an AP that receives a request from the STA. This can also be a relay that receives a request from the STA.

In some embodiments, a switching entity can transmit a relay to relay transition request message. The request message can include at least one or more of the information items as indicated in Table 13.

TABLE 13

| Information | |
|---|---|
| items | Description |
| New relay(s) | An information item to describe the identity of the |
| info list | new/preferred relays. E.g., MAC address. STA can check |
| | for all possible relays in the vicinity and create a |
| | preference list to send to the AP. If STA wants to |
| | switch to AP, then it can indicate the AP's |
| | identifier here instead. |
| Requested | An information item to describe the time at which |
| transition | the switching can occur. E.g., the number of TBTTs |
| time | from the current TBTT. |
| Reason | An information item that can describe the reason |
| information | for switching. E.g., reason code. |
| Reference | An information item that can serve as a reference |
| information | for the request message. E.g., Dialog token. |

The above information items can be transmitted together or separately and can be transmitted as a part of any existing frame/element/field/subfield in the standard or can be a part of newly defined ones.

In some embodiments, the processing entity can transmit a transition response message. This message can be transmitted in a solicited manner (e.g., in response to the relay to relay transition request message) or in an unsolicited manner (e.g., if the processing entity determines a transition is needed on its own). The response message can include at least one or more of the information items as indicated in Table. 14.

TABLE 14

| Information | |
|---|---|
| items | Description |
| Relay info | An information item that can indicate the relay that the |
| | STA can/has been switched to. E.g., relay MAC address. |
| Transition | An information item that can indicate the time at which |
| time | the switching can occur. E.g., the number of TBTTs from |
| | the current TBTT. |
| Status code | An information item that can indicate the status of the |
| | request. E.g., success, failure. |
| Reference | An information item that can serve as a reference for |
| information | the request to which the response corresponds to. E.g., |
| | same dialog token as in the request message. |

The above information items can be transmitted together or separately and can be transmitted as a part of any existing frame/element/field/subfield in the standard or can be a part of newly defined ones.

In some embodiments, the switching entity (e.g., STA) can request a list of potential relays from the processing entity (e.g., the AP). The switching entity can do so by transmitting a request message which can include at least one or more of the information items as indicated in Table 15.

TABLE 15

| Information | |
|---|---|
| items | Description |
| Reference | An information item that can serve as a reference for the |
| information | request. E.g., dialog token. |
| Current relay | An information item that can serve as a reference for the |
| information | current relay. E.g., Current relay MAC address. |
| Request | An information item that can indicate that the STA is |
| indicator | requesting new relay information. E.g., a field that can |
| | take a predetermined value if the STA is making the |
| | request, a reason code, etc. |

The above information items can be transmitted together or separately and can be transmitted as a part of any existing frame/element/field/subfield in the standard or can be a part of newly defined ones.

In some embodiments, upon receiving the request message from the switching entity, the processing entity can process the message and transmit a response message to the switching entity. The response message can include at least one or more of the information items as indicated in Table 16. The response entity can include information about one or more than one relay.

TABLE 16

| Information | |
|---|---|
| items | Description |
| Reference | An information item that can serve as a reference for the request to |
| information | which the response corresponds to. E.g., dialog token |
| New relay | An information item that can serve as a reference for the new relay(s). |
| reference | E.g., MAC address, AID, etc. |
| Relay | An information item that can describe the reachability of the relay, |
| information | security, capabilities of the relay, mobility domain of the relay, etc. |
| Operation | An information item that can describe the operating class which can |
| information | indicate the channel set, country, operation class, channel number, etc. |
| | for the relay(s) indicated above. |
| Channel | An information item that can describe the last known operating channel |
| information | of the relay(s) indicated above. |
| PHY | An information item that can describe the PHY type of the relay. |
| information | |
| Root AP | An information item that can describe the link(s) on which the relay can |
| communication | receive frames from/transmit frames to the root AP |
| link information | |
| STA | An information item that can describe the link(s) on which the relay can |
| communication | receive frame from/transmit frames to the end device. This can be the |
| link information | same set of links as those used for communication with the AP and can |
| | be indicated together with the above information item. |
| Relay capability | An information item that can describe the capability of the relay node. |
| | E.g., supported data rates for transmission to and from the end device |
| | and for transmission to and from the AP, queuing delays at the relay, |
| | transmit power level constraints, features supported (e.g., rTWT), etc. |
| Relay type | An information item that can indicate the type of the relay. E.g., if this is |
| | an amplify and forward relay or a decode and forward relay. |
| Relay device | An information item that can describe the maximum number of nodes |
| limit | that the relay can support if such a limit exists for the relay. E.g., relay |
| | can consider its own power save and QoS constraints and determine how |
| | many STAs it can serve. |
| Relay per device | An information item that can describe the maximum amount of traffic |
| load limit | load that the relay can support per device. |
| Service pause | An information item that can describe if the device has temporarily |
| | paused its relay services. |
| AP signal | An information item that can describe the received signal strength of the |
| strength | AP at the relay. This can enable the STA to choose the relay that has the |
| | strongest signal strength from the AP. E.g., RSSI, SNR, SINR, etc. |
| Relay signal | An information item that can describe the received signal strength of the |
| strength | relay at the AP. This can enable the STA to choose the relay that has the |
| | strongest signal strength at the AP. E.g., RSSI, SNR, SINR, etc. |
| AP and relay | An information item that can indicate an estimate of the communication |
| communication | rate for the path between the relay and the AP (e.g., net rate, downlink |
| speed | rate, uplink rate, etc.). For instance, this can be an estimate of the |
| information | communication rate for AP to relay path that the STA can get if it |
| | communicates via the relay. The relay can take into account the actual |
| | communication rate and if it is currently using the link for other traffic |
| | (e.g., relay's own traffic, traffic of relay's BSS if relay is a Mobile |
| | AP/AP, traffic of other STAs which the relay is serving, etc.) it can |
| | estimate how much communication rate can be experienced by a new |
| | STA when it starts to communicate via the relay. The relay can update |
| | this rate each time an STA joins the relay. For MLO operation, this can |
| | be either a per link estimate and/or an aggregate estimate. |
| Relay and STA | An information item that can indicate the relay to STA communication |
| communication | rate for the path between the relay and the STA (e.g., net rate, downlink |
| speed | rate, uplink rate, etc.). In some embodiments, this can be an estimate of |
| information | the communication rate for relay to STA path that the STA can get if it |
| | communicates via the relay. The relay can take into account the actual |
| | communication rate and if it is currently using the link for other traffic |
| | (e.g., relay's own traffic, traffic of relay's BSS if relay is a Mobile |
| | AP/AP, traffic of other STAs which the relay is serving, etc.) it can |
| | estimate how much communication rate can be experienced by a new |
| | STA when it starts to communicate via the relay. The relay can update |
| | this rate each time an STA joins the relay. For MLO operation, this can |
| | be either a per link estimate and/or an aggregate estimate. |
| End to end | An information item that can indicate the end to end communication rate |
| communication | that STA can get if it communicates via the relay. In some embodiments, |
| speed | the relay can provide this information based on a reference STA (the |
| information | reference STA's signal strength to the relay, bandwidth, etc. can be |
| | either a pre-known value based on the spec or can be separately |
| | advertised by the relay as an additional information item). For MLO |
| | operation, this can be either a per link estimate and/or an aggregate |
| | estimate. |
| Channel | An information item that can describe the channel statistics such as |
| statistics | CCA, channel utilization, idle time, etc. This can also be per link and can |
| | be advertised either on the same link and/or in a cross link manner. This |
| | information can be for the path between the relay and the AP and/or the |
| | path between the relay and the STA. |
| Resource | An information item that can describe any kind of resource constraints |
| constraints | such as the buffer capacity that the relay has or can use for relay |
| | operation. E.g., if the relay has hardware limitations and can dedicate |
| | only a certain portion of its buffer capacity for buffering relayed traffic, |
| | then it can make this advertisement. This information can comprise any |
| | description of buffer configuration, buffer sizes, buffer characteristics, |
| | buffer management policies for certain traffic types, etc. This can be |
| | useful for the STA to choose a relay based on its buffer capacity and one |
| | that is suited to its own traffic characteristics. E.g., if the STA has a bulk |
| | download that will have bursty traffic with large burst lengths, then this |
| | information can help it choose a relay that can provide a bigger buffer |
| | for relay operations. On the other hand, if the STA's traffic is not going |
| | to require big buffer sizes, then it can choose a relay that can provide a |
| | smaller buffer size. |
| Transmit power | An information item that can describe the transmit power information for |
| information | the relay. E.g., the relay can advertise the transmit power per |
| | link/transmit power configuration per link. |

The above information items can be transmitted together or separately and can be transmitted as a part of any existing frame/element/field/subfield in the standard or can be a part of newly defined ones.

In some embodiments, if the switching entity is the STA, the STA can transmit the request to the AP/relay and receive the response from the AP/relay. Upon receiving the response, the STA can determine the new relay to transition to.

In some embodiments, if the switching entity is the AP, then the AP can transmit an unsolicited response to the STA/relay. If the STA receives the response from the AP, then the STA can choose the new relay and transition to it. If the relay receives the response from the AP, the relay can assist the STA to transition to the new relay.

In some embodiments, if the switching entity is the relay, the relay can transmit an unsolicited response to the STA/AP. Both the STA and the AP can then understand the relay's intention to switch the STA to a new relay.

In some embodiments, if the processing entity is the AP, the AP can obtain information about other potential relays that the STA can transition to. These can be relays that are serving the AP and can already be associated with the AP with an indication to serve as a relay and/or already serving as a relay for other STAs. The AP can determine the relay's availability to provide relay service to the current STA by considering a number of factors such as relay's power constraints, load, buffer constraints, among others. The AP can also make a negotiation with the relay and perform the relay search procedure.

In some embodiments, if the processing entity is the relay, the relay can either obtain information about the potential relays on its own and/or can forward the request to the AP and request the information from the AP. The relay can then generate a response and transmit to the STA.

In some embodiments, the new relay can be informed about the transition. This can be done by transmitting an intimation message to the relay. The intimation message can include at least one or more of the information items as indicated in Table 17.

TABLE 17

| Information | |
|---|---|
| items | Description |
| STA | An information item that can describe the STA's identity. |
| identifier | E.g., STA MAC address, AID, etc. |
| Transition | An information item that can describe the time at which the |
| time | transition of the STA can occur. E.g., the number of TBTTs |
| | from the current TBTT at which the transition can occur. |
| STA | An information item that can describe the PHY and/or |
| information | MAC capabilities of the STA, the operation information, |
| | channel information, operating link information, etc. |
| Direction | An information item that can indicate the direction(s) of |
| information | the traffic that can be relayed. E.g., downlink, uplink, etc. |

The above information items can be transmitted together or separately and can be transmitted as a part of any existing frame/element/field/subfield in the standard or can be a part of newly defined ones.

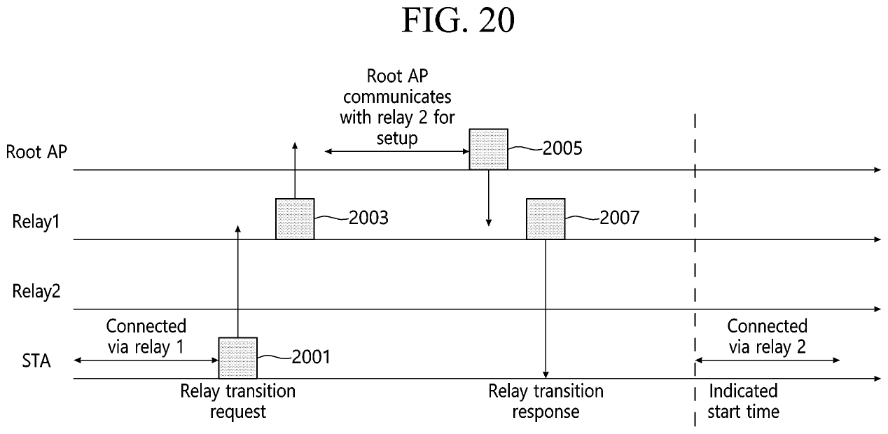

FIG. 20 illustrates a timeline for STA switching relays in accordance with an embodiment. As illustrated, the STA may want to switch from relay 1 to relay 2. STA can transmit a relay transition request message 2001 to the current relay, relay 1, which the current relay can forward the relay transition request message 2003 to the root AP. Upon receiving the message 2001 from the STA, the root AP can then communicate 2005 with relay 2 for setup and relay 1 can transmit a relay transition response message 2007 to the STA. Thereafter, at the indicated time, the STA can transition to relay 2 and start transmitting and/or receiving traffic via relay 2.

In some embodiments, the STA can transmit the relay transition request to the current relay. The relay can handle the switching process and inform the new relay. Upon processing the transition request, the current relay can transmit a relay transition to the STA. At the indicated, the STA can transition to the new relay.

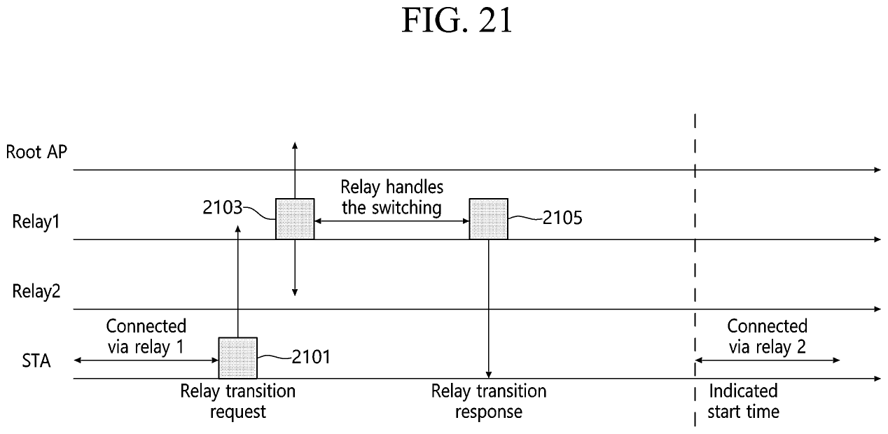

FIG. 21 illustrates a timeline for an STA relay transition in accordance with an embodiment. As illustrated, the STA can be connected via relay 1, and can transmit the relay transition request 2101 to the current relay, relay 1. The relay 1 can handle the switching process and inform, via message 2103, the new relay (relay 2) and the root AP. Upon processing the transition request, the current relay (relay 1) can transmit a relay transition response 2105 to the STA. At the indicated, the STA can transition to the new relay, relay 2.

In some embodiments, the STA can transmit the relay transition request to the new relay. The new relay can transmit a relay transition response to the root AP and the STA. Upon receiving the response, at the indicated start time, the STA can transition to the new relay.

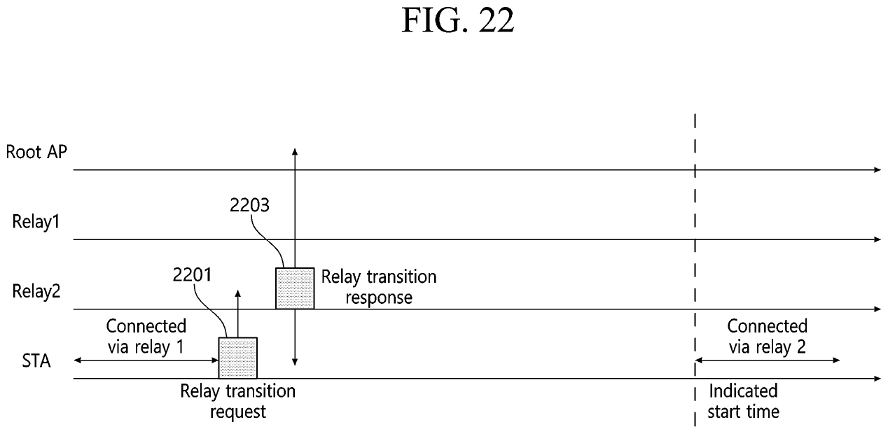

FIG. 22 illustrates a timeline for an STA switching relays in accordance with an embodiment. As illustrated, the STA can be connected via relay1. The Sta can transmit a relay transition request 2201 to the new relay, relay 2. The new relay, relay 2, can transmit a relay transition response 2203 to the root AP and the STA. Upon receiving the response, at the indicated start time, the STA can transition to the new relay (relay 2).

In some embodiments, an AP that can support a relay to relay transition procedure can advertise the support in one or more frames that it transmits. E.g., management frame such as beacons, probe responses, etc. This can enable the STA to understand which procedure to start when performing relay to relay transition.

In some embodiments, a relay that can support a relay to relay transition procedure can advertise the support in one or more frames that it transmits. E.g., management frames such as beacons, probe responses, etc.

In some embodiments, an STA that can support a relay to relay transition procedure can advertise the support in one or more frames that it transmits. E.g., management frame such as probe requests, (re)association requests, etc.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, the first STA comprising:
a memory;
a processor coupled to the memory, the processor configured to:
perform a relay operation for a second STA that relays a frame between the second STA and a third STA;
determine a change in an operational status of the first STA that is indicative of an overload condition of the first STA;
determine to suspend the relay operation for the second STA based on the operational status; and
transmit, to the second STA, a relay suspension message that indicates a suspension of the relay operation for the second STA.

2. The first STA of claim 1, wherein the third STA is an access point (AP) STA.

3. The first STA of claim 1, wherein the operational status includes a traffic load of the first STA or a number of other STAs for which the first STA performs relay operations.

4. The first STA of claim 1, wherein the overload condition is based on a Quality of Service (QoS) requirement of the first STA or a QoS requirement of the second STA.

5. The first STA of claim 1, wherein the processor is further configured to:
determine that a condition to resume the relay operation for the second STA is met; and
transmit, to the second STA, a relay resumption message that indicates a resumption of the relay operation for the second STA.

6. The first STA of claim 2, wherein the processor is further configured to:
transmit, to the AP, a request message to negotiate suspension of the relay operation;
receive, from the AP, a response message that includes indication for the suspension of the relay operation; and
suspend the relay operation based on the indication included in the response message.

7. The first STA of claim 1, wherein the processor is further configured to advertise the suspension of the relay operation to one or more STAs.

8. The first STA of claim 1, wherein the relay operation is a first relay operation, wherein the processor is further configured to continue to perform a second relay operation for a fourth STA and the second relay operation for the fourth STA relays a frame between the fourth STA and a fifth STA.

9. The first STA of claim 2, wherein the processor is further configured to:
receive, from the AP, a request message that requests information on the operational status of the first STA; and
provide, to the AP, a response message that includes information on the operational status of the first STA, wherein the AP advertises the operational status of the first STA.

10. The first STA of claim 1, wherein the relay suspension message includes a time at which the relay operation will be suspended.

11. A first station (STA) in a wireless network, the first STA comprising:
a memory;
a processor coupled to the memory, the processor configured to:
transmit frames to a second STA that performs a first relay operation that relays a frame between the first STA and a third STA;
receive a relay suspension message from the second STA indicating a suspension of the first relay operation, wherein the second STA experiences an overload condition; and
transmit a frame to the third STA directly or via a fourth STA that performs a second relay operation.

12. The first STA of claim 11, wherein the third STA is an access point (AP) STA.

13. The first STA of claim 11, wherein the processor is further configured to:
receive, from the second STA, a relay resumption message that indicates a resumption of the first relay operation; and
resume transmitting, to the second STA, frames to be relayed by the second STA to the third STA.

14. The first STA of claim 11, wherein the processor is further configured to:
transmit, to the second STA, a request message that requests an operational status of the second STA;
receive, from the second STA, a response message that includes the operational status of the second STA; and
advertise the operational status of the second STA to one or more STAs.

15. The first STA of claim 11, wherein the processor is further configured to advertise one or more STAs that have a capability to perform a relay operation to an STA associated with the first STA.

16. The first STA of claim 11, wherein the processor is further configured to transmit a switch message to the second STA that indicates that the first STA intends to switch to the fourth STA, wherein the fourth STA will provide a third relay operation for the first STA.

17. A computer-implemented method for wireless communication at a first station (STA) in a wireless network, the method comprising:
performing a relay operation for a second STA that relays a frame between the second STA and a third STA;
determining a change in an operational status of the first STA that is indicative of an overload condition of the first STA;
determining to suspend the relay operation for the second STA based on the operational status; and
transmitting, to the second STA, a relay suspension message that indicates a suspension of the relay operation for the second STA.

18. The computer-implemented method of claim 17, further comprising:
determining that a condition to resume the relay operation for the second STA is met; and
transmitting, to the second STA, a relay resumption message that indicates a resumption of the relay operation for the second STA.

19. The computer-implemented method of claim 17, wherein the operational status includes a traffic load of the first STA or a number of other STAs for which the first STA performs relay operations.

20. The computer-implemented method of claim 17, wherein the overload condition is based on a Quality of Service (QoS) requirement of the first STA or a QoS requirement of the second STA.
